(19) United States
(12) Patent Application Publication
(10) Pub. No.: US 2007/0200824 A1
(43) Pub. Date: Aug. 30, 2007

(54) Wireless foldable mouse

(76) Inventor: Eugene Kim Choo, San Diego, CA (US)

Correspondence Address: ROGITZ & ASSOCIATES, 750 B STREET, SUITE 3120, SAN DIEGO, CA, 92101, US

(21) Appl. No.: 11/361,475

(22) Filed: Feb. 24, 2006

(51) Int. Cl. G09G 5/08

(52) U.S. Cl. 345/163

(57) ABSTRACT

A wireless foldable mouse can be unfolded into a thin configuration for mechanical engagement with a computer, and folded into a thick configuration for wireless mouse input to the computer. Also, the mouse while distanced from the computer can be unfolded to reveal remote control buttons so that the mouse can be used to, e.g., control a slide show.

### I. FIELD OF THE INVENTION

The present invention relates generally to wireless computer mice.

### II. BACKGROUND OF THE INVENTION

Wireless computer mice have been provided that can communicate with computers to input point and click signals without the need for cords. As understood herein, a computer mouse by nature cannot be too small, because otherwise it is not ergonomic to use. As further understood herein, a cordless mouse tends to be big due to its design, requiring as it does a relatively bulky battery and a wireless transceiver. Because of both of these size-increasing factors, the present invention recognizes that it can be difficult to make a mouse sufficiently thin to fit into a relatively shallow storage space (typically 12.7 mm in depth) on a computer. This in turn is undesirable because it means that a user must either separately carry a wireless mouse with the computer, with the possibility of forgetting to bring the mouse along with the computer, or the user must use a cord mouse that is permanently attached to the computer and thus be forced to contend with untangling cords, etc.

### SUMMARY OF THE INVENTION

A wireless foldable mouse is foldable about a hinge to a thin configuration to facilitate mechanical engagement with a receptacle of a computer. The mouse can be folded into a thick configuration to facilitate wireless mouse input to the computer.

In non-limiting implementations the mouse includes remote control buttons to facilitate remote control of, e.g., a slide show. The remote control buttons are not exposed when the mouse is in the thick configuration, but are exposed when the mouse is in the thin configuration. The buttons may have functions such as volume control, fast forward, rewind, pause, play, forward, backward, next, and back. The hinge may be established by a ribbon connector and the mouse may have a signal generator element such as a rollable ball or optical sensor so that when the mouse is moved over a surface, pointing signals can be generated by motion of the ball.

In another aspect, a method includes providing a computer pointing device and unfolding the pointing device to a thin configuration. The method then includes mechanically engaging the pointing device with a computer while in the thin configuration. If desired, when engaged with the computer the battery of the pointing device can be recharged and its wireless transmitter turned off. The pointing device may be disengaged from the computer and folded into a thick configuration, in which pointing signals can be generated with the pointing device and wirelessly transmitted to the computer.

In still another aspect, a computer system includes a computer formed with a receptacle, and a mouse including an upper part and a lower part pivotably engaged with the upper part for movement between a thick configuration, wherein a surface of the upper part is substantially flush with a surface of the lower part, and a thin configuration, wherein the surfaces are distanced from each other and lie in substantially the same plane as each other. The mouse can be securely disposed in the receptacle in the thin configuration but not in the thick configuration.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram showing the mouse in the unfolded configuration engaged with a computer such as a laptop computer for charging the battery of the mouse;

FIG. 2 is a schematic diagram showing the mouse in the folded configuration, electrically but not mechanically engaged with the computer;

FIG. 3 is a top plan view of the mouse in the folded configuration, schematically showing the battery and transceiver;

FIG. 4 is a side elevational view of the mouse in the folded configuration;

FIG. 5 is a rear plan view of the mouse in the folded configuration;

FIG. 6 is a side elevational view of the mouse in the unfolded configuration; and

FIG. 7 is a top plan view of the mouse in the unfolded configuration.

### DETAILED DESCRIPTION OF THE PREFERRED EMBODIMENT

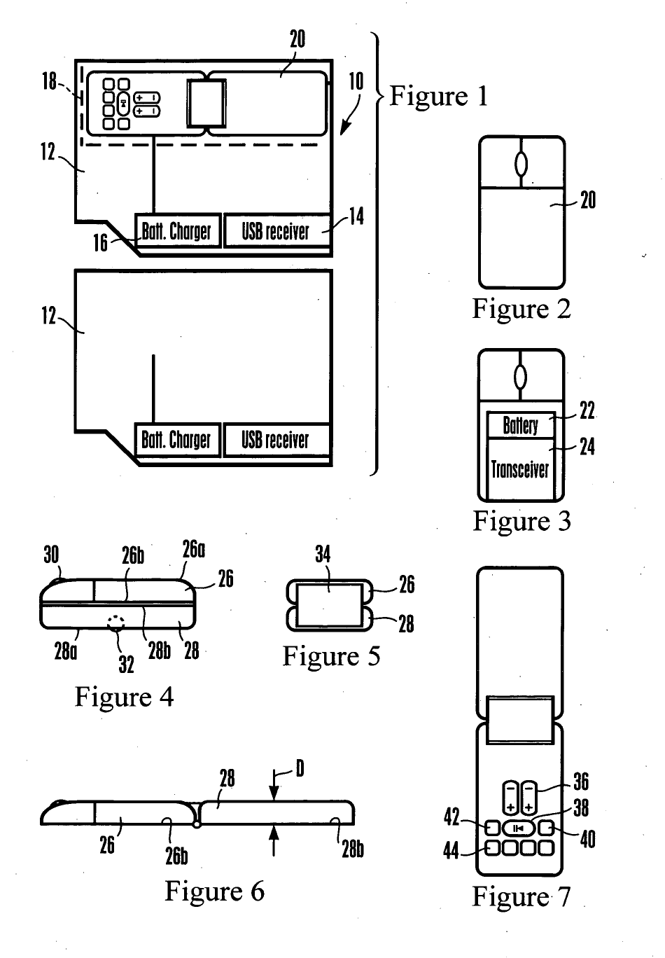

Referring initially to FIG. 1, a system is shown, generally designated 10, that includes a computer 12 such as but not limited to a laptop or notebook computer, such as, for instance, a Sony VAIO computer (VAIO is a trademark of Sony). As shown in FIG. 1, the computer 12 can include a wireless receiver 14 such as but not limited to a RF or IR universal serial bus (USB) wireless receiver and a battery charger 16. Also, the computer 12 includes switches for power management in accordance with disclosure below. The computer 12 is formed with a receptacle 18 that can engage a wireless or cordless mouse 20. The receptacle 18 may be formed in an exposed top or bottom surface of the computer 12 or it may be formed in the side of the computer 12 and the mouse 20 slid into the receptacle 18 through a slot.

In any case, the depth of the receptacle 18 (the dimension into the paper looking down on FIG. 1) preferably is approximately equal to the thickness of the mouse 20 in the unfolded thin configuration shown in FIG. 1, so that the mouse 20 snugly fits into the receptacle 18 in the unfolded configuration and cannot fit into the receptacle 18 when in the folded configuration discussed further below. When the mouse 20 is engaged as shown in FIG. 1 with the receptacle 18, the battery charger 16 charges the below-disclosed battery of the mouse 20 and the mouse (and/or computer) opens switches or otherwise deenergizes the wireless transceivers within the computer and mouse to save the power consumption.

As shown in cross-reference to FIGS. 1 and 2, the mouse 20 has a foldable design. More specifically, the mouse 20 can be folded in half as shown in FIG. 2 to a thick configuration for improved ergonomics, wherein the mouse may be used in a conventional mouse mode to wirelessly input pointing signals (and clicking signals if desired) to the computer 12. The mouse 20 may be unfolded to the thin configuration shown in FIG. 1 for storage in the receptacle 18 and for additional non-limiting purposes discussed further below.

Now referring to FIGS. 3-7, the mouse 20 has a plastic housing containing at least one battery 22 and a wireless transceiver or transmitter 24 that is configured to communicate with the receiver 14 in the computer 12. The battery 22 powers the mouse 20 and can be recharged by the charger 16 in the computer 12 when the mouse 20 is engaged with the computer receptacle 18.

FIG. 4 shows that the mouse housing is composed of upper and lower parts 26, 28. In the folded configuration, a rotatable thumbwheel 30 can be exposed on the upper part 26, and a motion signal generator 32 such as an optical, a rollable ball, etc. is exposed on the bottom of the lower part 28 so that when the mouse is moved over a surface, pointing signals can be generated by the motion signal generator 32 in accordance with mouse principles known in the art. Additional pointing signals and/or clicking signals can be generated using the thumbwheel 30 in accordance with mouse principles known in the art. The signals are wirelessly conveyed to the computer 12 by the wireless transceiver 24 and wireless receiver 14.

As shown, the upper surface 26a of the upper part 26 can be ergonomically rounded, while the bottom surface 28a of the lower part 28 preferably is flat. Also, in the folded, thick configuration the inner surface 26b of the upper part 26 is substantially flush against the inner surface 28b of the lower part 28.

FIG. 5 shows that the upper and lower parts 26, 28 can be connected by a hinge 34. In one non-limiting implementation the hinge may be embodied by an electrical ribbon connector, it being understood that other hinge types, e.g., rod-and-groove mechanical hinges, etc. may be used. In any case, the parts 26, 28 may be folded about the hinge 34 against each other as shown in FIGS. 2-5 into a relatively thick configuration to ergonomically facilitate mouse operation, and unfolded away from each other in the thin configuration shown in FIGS. 1, 6, and 7 to lie in the same plane as each other to facilitate storage in the receptacle 18. Stated differently, in the unfolded, thin configuration the inner surface 26b of the upper part 26 is folded away from and is co-planar with the inner surface 28b of the lower part 28. As shown in FIG. 6, in the thin configuration the mouse 20 defines a thickness “D” that is marginally less than the depth of the receptacle 18 shown in FIG. 1, whereas it can be appreciated looking at FIG. 4 that while in the thick configuration, the effective thickness of the mouse is greater than the depth of the receptacle 18.

Additionally, if desired the mouse 20 can be formed with remote control buttons to facilitate use as a remote control device for one or more applications on the computer 12. As best shown in FIG. 7, the buttons can include, without limitation, volume up/down buttons 36 to cause the computer to increase or decrease volume, a fast forward button 38, a rewind button 40, a pause button 42, a play button 44, and so on to facilitate, e.g., wirelessly controlling a slide show on the computer 12. Forward, backward, next, and back buttons can also be provided to control slide shows and multimedia presentations. In any case, as can be appreciated in cross-reference to FIGS. 4 and 7, in a non-limiting embodiment the remote control buttons can be on an inner surface of one (or both) of the parts 26, 28 so that the buttons are not exposed when the mouse 20 is in the thick configuration and are exposed only when the mouse 20 is in the thin configuration.

While the particular WIRELESS FOLDABLE MOUSE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A wireless mouse foldable about a hinge to a thin configuration to facilitate mechanical engagement with a receptacle of a computer, the mouse being foldable into a thick configuration to facilitate wireless mouse input to the computer.

2. The mouse of claim 1, wherein the mouse includes remote control buttons to facilitate remote control of a slide show, the remote control buttons not being exposed when the mouse is in the thick configuration and being exposed when the mouse is in the thin configuration.

3. The mouse of claim 2, wherein at least one remote control button can be manipulated to generate a volume control signal.

4. The mouse of claim 1, wherein the hinge is established by a ribbon connector.

5. The mouse of claim 1, wherein the mouse includes a motion signal generator so that when the mouse is moved over a surface, pointing signals can be generated by the motion signal generator.

6. The mouse of claim 2, wherein at least one remote control button has a function selected from the group consisting of: fast forward, rewind, pause, play, forward, backward, next, and back.

7. A method comprising:
providing a computer pointing device;
moving the pointing device to a thin configuration;
mechanically engaging the pointing device with a computer while in the thin configuration;
disengaging the pointing device from the computer;
moving the pointing device to a thick configuration;
generating pointing signals with the pointing device; and
wirelessly transmitting the pointing signals to the computer.

8. The method of claim 7, comprising:
deenergizing at least one wireless communication component in the pointing device when the pointing device is engaged with the computer.

9. The method of claim 7, comprising:
charging a battery of the pointing device when the pointing device is engaged with the computer.

10. The method of claim 7, comprising generating remote control signals using the pointing device when the pointing device is disengaged from the computer in the thin configuration.

11. The method of claim 7, wherein the pointing device is a mouse.

12. The method of claim 11, wherein the mouse includes plural remote control buttons having functions selected from the group consisting of: volume control, fast forward, rewind, pause, play, forward, backward, next, and back.

13. A computer system, comprising:
a computer formed with a receptacle; and
a mouse including an upper part and a lower part pivotably engaged with the upper part for movement between a thick configuration, wherein a surface of the upper part is substantially flush with a surface of the lower part, and a thin configuration, wherein the surfaces are distanced from each other and lie in substantially the same plane as each other.

14. The system of claim 13, wherein the mouse can be used to generate pointing signals in the thick configuration.

15. The system of claim 14, wherein the mouse includes remote control buttons to facilitate remote control of a slide show, the remote control buttons not being exposed when the mouse is in the thick configuration and being exposed when the mouse is in the thin configuration.

16. The system of claim 15, wherein at least one remote control button has a function selected from the group consisting of: volume control, fast forward, rewind, pause, play, forward, backward, next, and back.

17. The system of claim 13, wherein the parts are joined by a hinge.

18. The system of claim 17, wherein the hinge is established by a ribbon connector.

19. The system of claim 13, wherein the mouse includes a rollable ball so that when the mouse is moved over a surface, pointing signals can be generated by motion of the ball.

20. The system of claim 13, wherein the mouse is cordless.
